(19) United States
(12) Patent Application Publication
(10) Pub. No.: US 2006/0212364 A1
(43) Pub. Date: Sep. 21, 2006

(54) System and method for a repeat customer transaction counter

(75) Inventor: Tabbatha Christie Lawe, Chapel Hill, NC (US)

Correspondence Address: ALUN L. PALMER, PATENT AGENT, 4300 PINEY CHURCH ROAD, WALDORF, MD, 20602, US

(73) Assignee: MyStoreCredit.com

(21) Appl. No.: 11/378,432

(22) Filed: Mar. 20, 2006

Related U.S. Application Data
(60) Provisional application No. 60/663,236, filed on Mar. 18, 2005.

(51) Int. Cl. G06Q 30/00

(52) U.S. Cl. 705/26

(57) ABSTRACT

Creating and displaying a repeat customer transaction counter showing a current cumulative count of repeat transactions for an individual seller at a market venue. The seller registers and identifies his/her self-verified existing repeat transaction count and/or uploads a file of historical transaction information to create a starting count. The seller is next sent HTML text for the display of the seller's unique repeat customer transaction counter. The cumulative count is continually incremented by subsequent transactions concluded by prior buyers. The counter image is presented in response to a call from the HTML text placed by the seller on a web page at a market venue or in an HTML enabled email sent to the buyer. The counter shows a cumulative repeat transaction count, indicating prior buyer trust in the seller, as evidenced by repeat purchases. Alternatively, a clock shows the elapsed time since the last repeat transaction.

### BACKGROUND OF THE INVENTION

1. Field of the Invention

This invention relates generally to systems and methods for enhancing trust in retail sales. This invention is particularly well suited for auctions or fixed price purchases executed at a market venue web site over networks including the Internet.

2. Description of the Background

Online transactions, like those generally conducted at eBay, Amazon and other such market venues, occur only after a seller can establish a measure of trust with a potential buyer. Buyers will not conduct transactions if they do not trust the unseen seller. This dynamic was emphasized by eBay's CEO Meg Whitman in an article for PC World magazine in 2001, where she was quoted as saying: “Trust and safety are at the core of eBay.” Systems that improve buyer trust are critical to online venues' success and to the success of individual sellers on these venues or sellers selling from their own e-commerce sites.

eBay, and all such market venue sites, provide a forum for buyers and sellers to conduct transactions. To help facilitate these transactions, multiple signals of trust are exhibited on the market venue's web selling pages. Examples of these trust signals include colored stars indicating seller levels such as “power seller”, “gold power seller” and the like. Furthermore, market venues provide a mechanism for buyers and seller to leave each other feedback. Feedback is usually positive, negative or neutral. Often, a market venue will allow for prominent display of the counts of total feedback scores and will show positive feedback scores as an important signal of trust for future buyers.

Academic papers, including “Trust Among Strangers in Internet Transactions: Empirical Analysis of eBay's Reputation System”, by Paul Resnick, and Richard Zeckhauser, have analyzed the importance of trust in online retail transactions and specifically the importance of signals of trust on eBay. Their paper exams the eBay feedback system and reviews its major drawbacks. The paper makes the point that: “Customer-scored reputation systems to date rely overwhelmingly on voluntarily provided information. This creates strong incentives to free ride, and quite possibly to Pollyanna (disproportionately positive) feedback.” The paper makes clear that the eBay feedback system is a critical element to eBay's success but is not without its drawbacks.

Additionally, various forms of certification marks have been developed by non-profit and for-profit entities to relay a measure of trust on market venue sites or e-commerce sites. These organizations, such as: BBBOnline, TRUSTe, WebAssured, SquareTrade, PayPal, CPAwebTrust and ReliableMerchants; all provide some level of a certification program that indicate a code of business standards or practices which sellers use to advertise or promotes trust for the seller. Once certified, the seller is given permission to display a certification image on the seller's item listing web page at the market venue. Generally, these certification programs provide a minimal level of trust since most have little, if any, independent verification.

Perhaps the most concrete form of trust between a buyer and a seller in retail transactions manifests itself when an individual buyer makes a repeat purchase with the same seller. Repeat purchases signal that a buyer trusts the seller enough to spend more of their own money and time with the seller. Considering the minimal “cost” of leaving positive feedback on a market venue site, a repeat purchase is clearly a superior demonstration of buyer trust. A market venue buyer incurs only a few seconds of time and no cash expenditure to leave positive feedback for a seller on a market venue such as eBay. Buyers considering leaving feedback may actually have a significant disincentive for leaving negative feedback since seller retaliation could also lead to a negative feedback score on the buyer's account.

On the other hand, repeat purchases require the buyer to seek out the seller's other listings, and then spend time reviewing the seller's offered listings, and finally, the buyer must commit money to conclude a repeat transaction with the seller. This expense in time and money provides a significantly high hurdle and signals greater trust by the buyer.

To efficiently signal prior buyer trust in a seller, the signals of trust must be easily viewed and understandable by the buyer during the buyer's purchase evaluation. Thus, it is critical that the buyer easily see and understand any trust signal offered by the seller. The eBay colored stars and positive feedback scores provide evidence of simple to understand and easily viewed trust signals. The positive feedback score in particular has proven effective in relaying trust. It is calculated by dividing the positive feedback received by the seller over the total feedback received by the seller. Thus, a high positive feedback score of 99.5%, for example, quickly relays to a potential buyer that the seller has a strong positive track record with initial sales—thus signaling a measure of trust and facilitating the transaction. However, this feedback score does not relay anything about the more concrete measure of repeat purchase transactions from prior buyers.

### SUMMARY OF THE INVENTION

Accordingly, several objects and advantages of my invention are providing any number, or type, of market venue sellers with a simple, readily understandable system to obtain a fair count of their own repeat customer transactions and to display that count on the seller's item selling web-pages or within outbound emails. The repeat customer counter further signals a significantly high level of prior buyer trust in the demonstrating seller.

The invention operates on the premise that capturing repeat transactions and displaying the seller's cumulative history of repeat transactions to new buyers will help increase the trust level for pending buyers and facilitate the completion of future transactions for the seller.

The preferred embodiments of the present invention provides a system and method for enabling an auction or fixed-price seller, referred to herein as the “seller,” to display an updated counter of the seller's repeat customer transactions on a web-page or within an email. This displayed repeat customer transaction counter acts as a signal of trust to viewing buyers.

After establishing the seller's account, including the establishment of existing repeat customer transactions by self-verification or through the uploading of completed transaction records, the system provides the seller with HTML text to display the seller's repeat customer transaction counter. In the preferred embodiment, this is provided via email. Subsequently, the system automatically receives transaction information for the seller from the seller's market venue or ecommerce web site. Received transactions are evaluated by a software program to determine if the buyer in the transaction is a prior buyer. When a repeat buyer transaction is identified, the system increments a cumulative counter of existing repeat transactions in the system's database. If the transaction is determined to be a new transaction, no increment is recorded but the new buyer user ID is recorded in the database for future comparison.

This system and method is comprised of a repeat customer counter registration by the seller. Seller registration occurs by providing the seller with access to a registration software program on a web server where the seller can initiate their repeat customer counter. The registration software updates a seller database which includes, but is not limited to, seller information including seller name, seller's market user ID, address, active/inactive status, billing information, as well the market venue the seller sells through and/or the web address of the seller's own store web site. In addition, each seller record in the seller database includes an updated count of cumulative repeat purchases.

The seller initiates the repeat customer counter system by updating and completing HTML forms within the repeat customer counter web site. Since the seller will most likely have been in business prior to registration, during seller registration the seller may optionally enter a self-certified count of existing repeat customer transactions. The self-certified count of repeat transactions becomes the starting point for the cumulative count of existing repeat transactions in the seller record for display in the repeat customer transaction counter.

Additionally, during registration the seller is given the option of uploading a file of existing prior transactions including buyer IDs to initiate the seller's transaction database. The registration software can receive this optional file and place the uploaded buyer IDs from the file into the seller's transaction database in the appropriate buyer ID fields. The sum total of multiple instances of the same buyer ID in prior transactions becomes the seller's starting point for the cumulative count of existing repeat transactions for the seller.

The seller provides for the system to receive transaction information from the seller's preferred market venue or the system may poll the market venue for transaction information for the seller.

Once the seller completes registration his/her repeat customer counter is established.

To display the repeat customer counter, the seller is given access to HTML text for inclusion on a web page or within an email. In the preferred embodiment, the access is given via an email sent to the buyer. Said email contains the HTML text.

The HTML text, when placed onto a web page or within a HTML enabled email, calls the seller's repeat customer counter image to the target location. The seller can place the provided HTML text on the market venue's listing web page or on the seller's own e-commerce web site or within outbound HTML enabled emails. Subsequently, when the buyer opens their browser on the market venue seller's item listing page, or opens the browser on to the seller's e-commerce listing page or the buyer opens an email with an HTML enabled email reader, the HTML code initiates a call to the system and the updated image of the seller's repeat customer counter is presented within the web-pages or email.

The system continually receives seller transaction information from the market venue or from the seller's e-commerce web site. Each transaction record is analyzed and stored in a seller transaction database. At a minimum, the transaction information includes the buyer ID. A software program evaluates if the buyer ID for the received transaction matches an existing buyer ID in the seller's database record. If so, the system increments the cumulative repeat customer transaction count in the seller's database record. If not, the buyer ID is recorded in the database as a first time buyer.

Whenever the image hosting server receives a call from the HTML code, it presents the most updated repeat customer counter image to the appropriate calling web-page or email reader so that the buyer sees the most recent expression of prior buyer trust as evidenced by the cumulative repeat customer transactions with that seller.

### BRIEF DESCRIPTION OF THE DRAWINGS

These and other features and advantages of the invention will now be described with reference to the drawings of certain preferred embodiments, which are intended to illustrate and not to limit the invention, and in which:

FIGS. 1A and 1B are high-level architectural drawings illustrating the primary components of a repeat customer transaction counter system for displaying a repeat customer transaction count as an image on a web-page or in an email.

FIG. 2 is a block flow diagram illustrating the method in accordance with the invention.

FIG. 3 is a diagram of information for a seller account record for use with one embodiment of the present invention

FIGS. 4A-4B are screen displays of the seller registration on-line form which is completed by the seller to create a seller database record.

FIG. 5 is a sample repeat customer counter image display.

FIG. 6 is a sample screen display of a market venue listing page with the repeat customer counter displayed.

FIG. 7 is a sample buyer HTML-enabled email with the repeat customer counter displayed.

### DETAILED DESCRIPTION

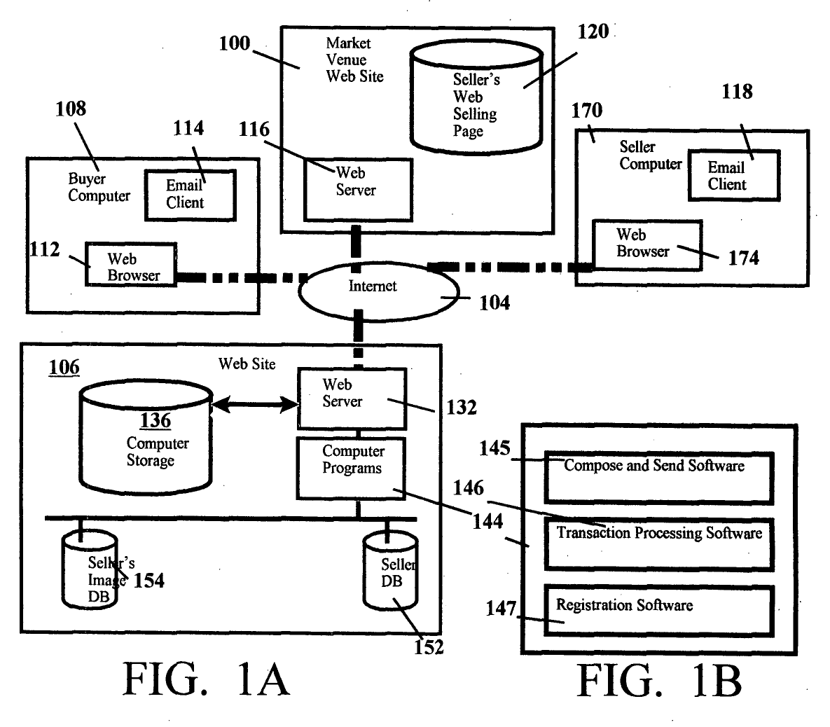

FIG. 1A is a high-level architectural drawing illustrating the primary components of a repeat customer transaction counter system for tracking an independent count of a seller's repeat customer transactions and to display that count on the seller's item selling web-pages or within outbound emails. The repeat customer transaction counter system includes a buyer computer 108, a market venue web site 100, a seller computer 170 and a repeat customer transaction system web site 106, all of which are linked together by the Internet 104.

The buyer computer 108 may be any type of computing device that allows the buyer to receive and respond to emails 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The market venue web site 100 is a web site such as eBay.com, Amazon.com or Yahoo.com, which provides various functionality for allowing sellers to post listings for sale and for buyers to make offers to purchase said listings via a highest bid or a fixed price buying method over the Internet using their Web browser. Typically, the market venue web site 100 will be operated by a business entity that handles marketing functions to attract both buyer and seller to its site. The market venue web site 100 handles technical tasks to facilitate posting listings for sale, subsequent transaction processing including bid recording and final winning bid determination, reporting associated with the sale of almost anything between a buyer and seller and the presentation of a seller's web selling page 120 to a buyer. The market venue web site uses a web server 116 to send information as HTML web page displays, HTTP files, and emails to various entities, including the buyer computer 108, the seller computer 170, and the repeat customer transaction counter system 106, over the internet 104 as is required to conduct appropriate transactions with each party.

The repeat customer transaction counter system web site 106 advantageously includes a web server 132 and HTML documents 136, a seller account database 152 and a seller image database 154 and multiple computer software programs 144 also shown in FIG. 1B. As seen in FIG. 1B, these comprise compose and send software 145, transaction processing software 146 and registration software 147.

The seller computer 170 may be any type of computing device that allows the seller to interactively browse Web sites via a Web browser 174 and allows the seller to receive and respond to emails 118. For example, the seller computer 170 may be a personal computer (PC) that runs the Windows 2000 operating system running Internet Explorer and accesses email through Microsoft Outlook.

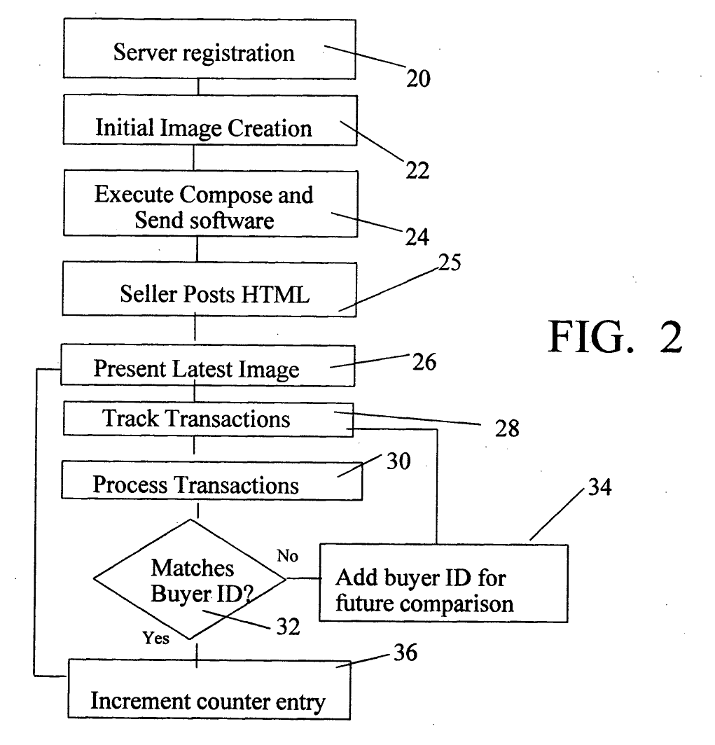

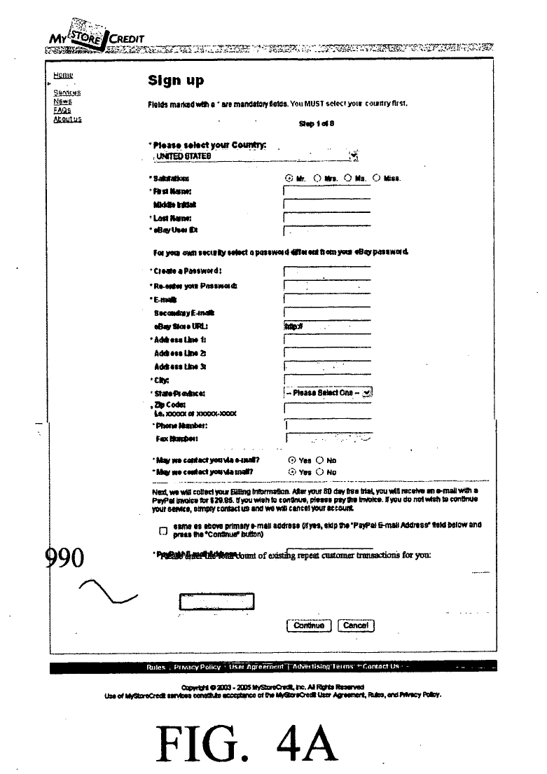

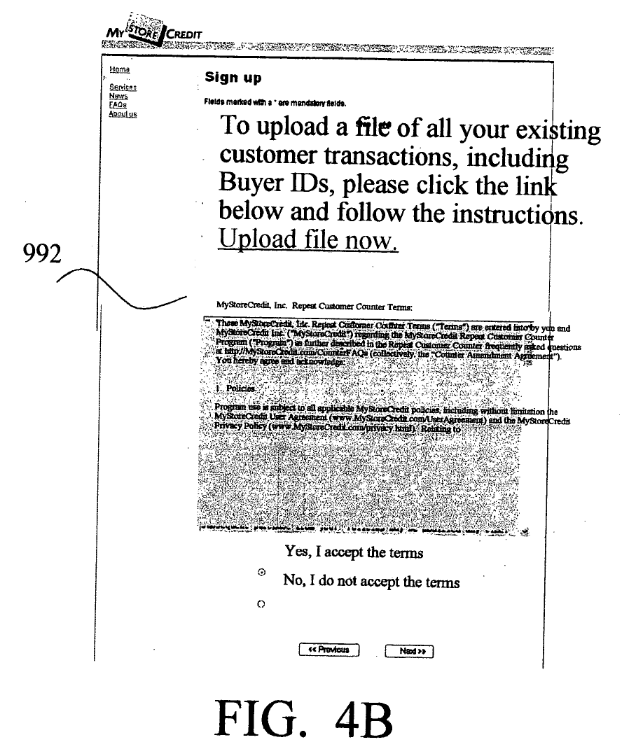

FIG. 2 is a general flow diagram of the method of this invention. Referring to this figure, the invention provides sellers with a mechanism to register for the repeat customer counter system. This activity is reflected as step 20 as detailed in the general flow diagram in FIG. 2. One embodiment of the marketing seller registration image 136 is illustrated in FIG. 4A-4B. In the preferred embodiment of the invention, sellers are presented with both the opportunity to enter a self-verified existing cumulative repeat transaction count 990 and the opportunity to upload a file of buyer IDs from the seller's prior purchases 992. If the seller only uploads a file of buyer IDs, the registration software 147 accepts the uploaded file and counts the total repeat buyer IDs in the file and places the sum of the buyer IDs into the seller cumulative repeat transaction count field 232 in the seller account database 152 and places unique buyer IDs into appropriate buyer ID fields 234. In this way, the system is calculating both the total repeat transactions encompassed in the file and establishes a total prior buyer ID database to compare against future transactions. If, during registration, the seller enters only a self-verified existing cumulative repeat transaction count 990, the entered number is placed by the registration software 147 in both the self-verified transaction count field 230 and the cumulative repeat transaction field 232. If, during registration, the seller enters both a self-verified existing cumulative repeat transaction count 990 and uploads a file of IDs from all prior purchases 992, the registration software 147 will place the entered self-verified existing cumulative transaction count number into the self verified transaction count field 230 in the seller account record database 152 and will accept the uploaded file and place the existing buyer IDs into buyer ID fields 234 and counts the total repeat buyer IDs and compares the count to the count in the self verified existing cumulative transaction count field 230 and places the larger of the two into the seller cumulative repeat transaction count field 232 in the seller account database 152.

Upon registration completion, the system creates the initial components of the seller's repeat customer transaction counter in a record within the system's seller image database 154 (Step 22). At step 24, the system executes the compose and send email software program 145 to send the seller an email containing unique HTML text capable of calling the repeat customer counter image for the appropriate seller to a web page or HTML enabled email. The email creation executed by the compose and send email software 145 includes combining the seller's email address from the seller's contact information 210 along with pre-defined text from the HTML docs 136 and sending the email via the internet 104 to be read by the seller using the seller's email client 118. At step 25, the seller opens the email and copies and pastes the HTML text into the appropriate place on the seller's web selling page 120 or into the appropriate place within the seller's email client 114.

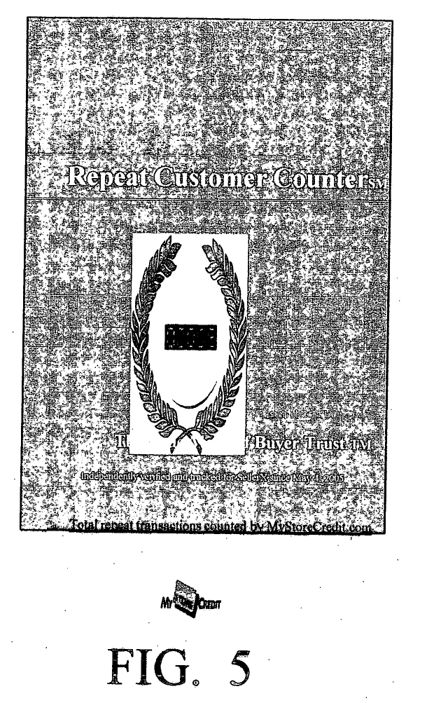

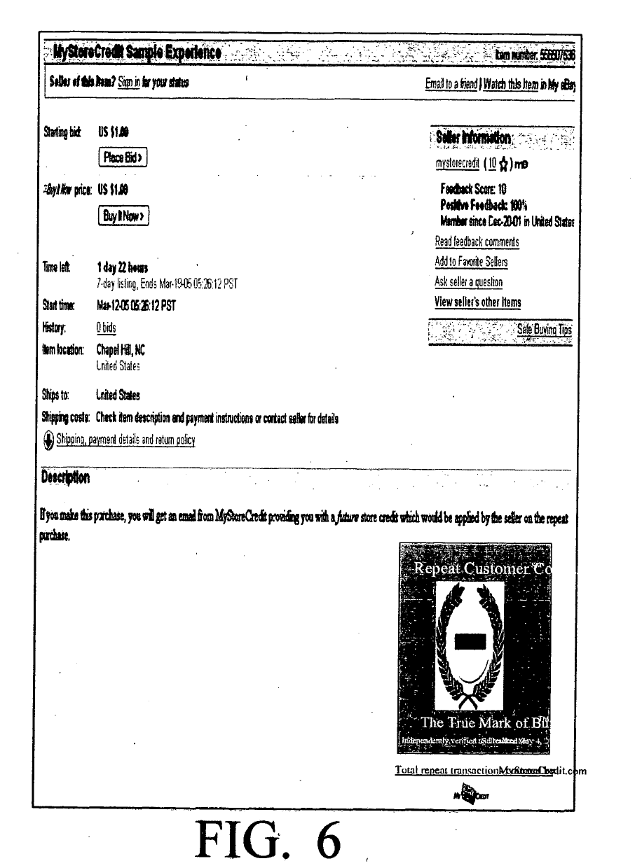

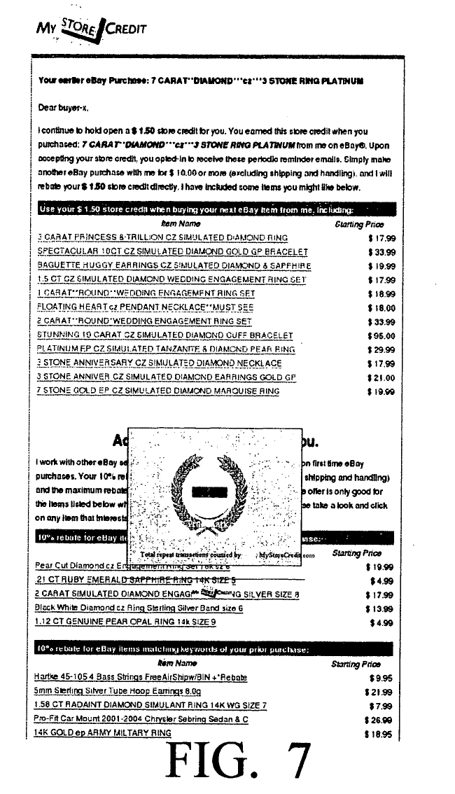

Subsequently, in Step 26, whenever a buyer uses his/her web browser 112 to open a seller's web selling page 120 which includes the HTML text or whenever a buyer opens an HTML enabled email message which includes the HTML text by using his/her email client 114, the system responds to the HTML text's call and the latest repeat customer transaction counter image is presented from within the seller image database 154 with the current cumulative repeat transaction count from the seller's transaction database 152 combined with appropriate HTML docs 136 and presented as the image through the web server 132 over the internet 104 to the correct calling location to display the repeat transaction counter of FIG. 5 on a web page FIG. 6 or in an email FIG. 7.

The system subsequently tracks seller transactions by capturing seller transactions from the Market venue web site 100, Step 28. In one embodiment of the invention, at the close of every market venue transaction for a registered seller, the Market Venue web site 100 sends an electronic message over the internet 104 to the repeat customer transaction counter system web site server 132 where the system processes the received transaction using the transaction processing software 146. In another embodiment, the transaction processing software 146 polls the market venue web server 116 over the internet 104 for any closed seller transactions. Once captured, at Step 30, each transaction is processed by the transaction processing software 146. In the preferred embodiment, the minimum transaction data captured is the buyer's market venue ID for the transaction. Alternatively, other transaction data, including purchase price, date and time of transaction, email address of the buyer, etc. are parsed and placed into appropriate corresponding fields in the seller account database 152.

At step 32, the transaction processing software 146 evaluates if the buyer ID from the received transaction matches any existing buyer IDs in the buyer ID fields 234 in the seller's record in the sellers account database 152. If no, Step 34, the new buyer ID is added into the new buyer ID field 242 in the seller's record in the seller account database 152 and the system returns to step 28 to track further transactions. If, in Step 32, a match is determined, the system moves to Step 36 and the seller's cumulative transaction count field 232 in the seller account database 152 is incremented by one. Next, the system returns to Step 26 to provide the latest cumulative repeat transaction counter image FIG. 5 to the next HTML call stimulated by a viewing buyer.

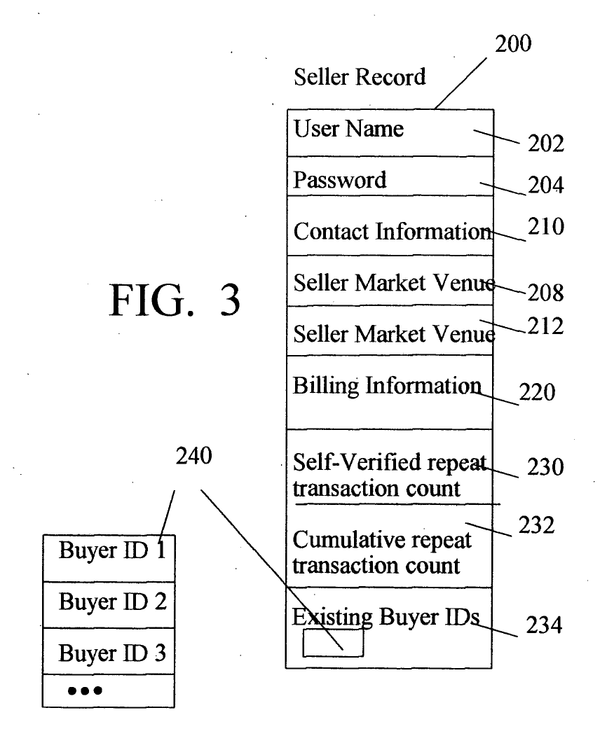

FIG. 3 is a diagram showing the types of information contained in a seller account record 200 in the seller account database 152. Each seller record 200 contains a user name 202 and a password 204, used to access the seller's account record. The account record also contains contact information 210, the seller's market venue ID 208 and the seller's preferred market venue 212. The account record 200 also contains billing information 220.

The self-verified repeat transaction count 230 contains a numeric count of the registering seller's self-verified repeat transactions entered during registration. The cumulative repeat transaction count 232 is the total count of repeat transactions determined during registration plus the total repeat transactions determined after registration in Step 32 from FIG. 2. The buyer ID set 234 for each seller account 200 may have zero or more unique buyer IDs 240.

One alternative envisioned for the invention is the substitution of a repeat customer clock to represent the same elements of a repeat customer counter. In this alternative to the invention, a clock representing the time since the last repeat customer purchase is displayed on the selling listing page in lieu of the repeat customer counter. The clock is refreshed to show the elapsed time since the most recent repeat customer purchase at each presentation to a potential buyer.

It will be appreciated by those skilled in the art that numerous modifications and variations are possible, and that the invention may be practiced otherwise than as specifically described herein, without departing from the scope thereof.

I claim:

1. A repeat customer transaction counter system, comprising:
a. a repeat customer transaction counter display image presented over a network, said counter display image including numeric characters representing current cumulative repeat customer transactions between a seller and said seller's repeat buyers; and,
b. a database of said seller transactions for said seller and said seller's said repeat buyers; and,
c. said database of said seller's said repeat transaction counter image including a count of the cumulative repeat transactions; and
d. a software program which provides for said seller registration, and which composes and sends email to said seller, and which receives transaction notification of said seller and said seller's buyers, and subsequently determines if said transaction was made by any of said seller's existing said buyers, and increments a count of cumulative repeat transactions accordingly; and
e. a server connected to said network to present said counter display image.

2. A repeat customer transaction counter system according to claim 1, in which said transaction notification is received from a market venue attached to said network.

3. A repeat customer transaction counter system according to claim 1, in which said transaction notification is received from an ecommerce web site attached to said network.

4. A repeat customer transaction counting system according to claim 1, in which said counter display image is presented in an email.

5. A repeat customer transaction counting system according to claim 4, wherein:
said email is HTML enabled.

6. A repeat customer transaction counting system according to claim 1, wherein said counter display image is presented on said seller's item listing page at said market venue.

7. A method for enabling a server to display an updated image of a cumulative count of repeat customer transactions for a seller on a web page comprising the steps of:
registering a seller,
determining an initial value of said cumulative count of said repeat customer transactions;
providing said seller with code to call an image of a repeat customer counter showing said count of said cumulative repeat customer transactions;
receiving a subsequent transaction record for said seller;
determining if said transaction was made by an existing customer of said seller;
incrementing said cumulative count of said repeat customer transactions accordingly; and
presenting an updated version of said image of said repeat customer counter when called.

8. The method according to claim 7, wherein:
said code to call said image of said repeat customer counter showing said count of said cumulative repeat customer transactions is HTML.

9. The method according to claim 7, wherein:
said step of determining said initial value of said cumulative count of said repeat customer transactions further comprises self-verification of said cumulative count of said repeat customer transactions by said seller.

10. The method according to claim 7, wherein:
said step of determining said initial value of said cumulative count of said repeat customer transactions further comprises counting prior buyer IDs in prior transactions.

11. The method according to claim 7, wherein:
said step of presenting an updated version of said image of said repeat customer counter comprises:
presenting said image of said repeat customer counter in an email.

12. The method according to claim 7, wherein:
said step of presenting an updated version of said image of said repeat customer counter comprises:
presenting said image of said repeat customer counter on said seller's item listing page at said market venue.

13. A method for enabling a server to display an updated image of a clock representing an elapsed time since a last repeat customer purchase for a seller on a web page comprising the steps of:
registering a seller,
determining said elapsed time since said last repeat customer transaction;
providing said seller with code to call an image of said clock representing said time since said last repeat customer purchase;
receiving a subsequent transaction record for said seller;
determining if said transaction was made by an existing customer of said seller;
restarting said clock representing said elapsed time since said last repeat customer purchase accordingly; and
presenting an updated version of said image of said clock representing said time since said last repeat customer purchase when called.

14. The method according to claim 13, wherein:
said code to call said image of said call said image of said clock representing said time since said last repeat customer purchase is HTML.

15. The method according to claim 13, wherein:
said step of determining said elapsed time since said last repeat customer transaction further comprises self-verification of said cumulative count of said repeat customer transactions by said seller.

16. The method according to claim 13, wherein:
said step of determining said elapsed time since said last repeat customer transaction further comprises detecting a transaction made by an existing customer of said seller.

17. The method according to claim 13, wherein:
said step of presenting an updated version of said image of said clock representing said time since said last repeat customer purchase comprises:
presenting said image of said clock representing said time since said last repeat customer purchase in an email.

18. The method according to claim 13, wherein:
said step of presenting an updated version of said image of said clock representing said time since said last repeat customer purchase comprises:
presenting said image of said clock representing said time since said last repeat customer purchase on said seller's item listing page at said market venue.
